(19) United States
(12) Patent Application Publication
(10) Pub. No.: US 2007/0095726 A1
(43) Pub. Date: May 3, 2007

(54) Chafftron

(76) Inventor: Tihiro Ohkawa, La Jolla, CA (US)

Correspondence Address: Neil K. Nydegger, Esq.;NYDEGGER & ASSOCIATES, 348 Olive Street, San Diego, CA, 92103, US

(21) Appl. No.: 11/261,113

(22) Filed: Oct. 28, 2005

(51) Int. Cl. B07C 5/00

(52) U.S. Cl. 209/639

(57) ABSTRACT

A device for separating high mass particles (M_{H}) and low mass particles (M_{L}) from each other includes a laser source for vaporizing a solid target material that contains M_{H} and M_{L}. The resultant vapor jet is directed along an axis and an injector directs a gas flow along a path through the vapor jet perpendicular to the axis of the vapor jet. This entrains M_{L} in the gas flow to thereby separate M_{L} from M_{H}. Collectors are respectively positioned on the axis for collecting M_{H} from the vapor jet, and on the path for collecting M_{L} from the gas flow.

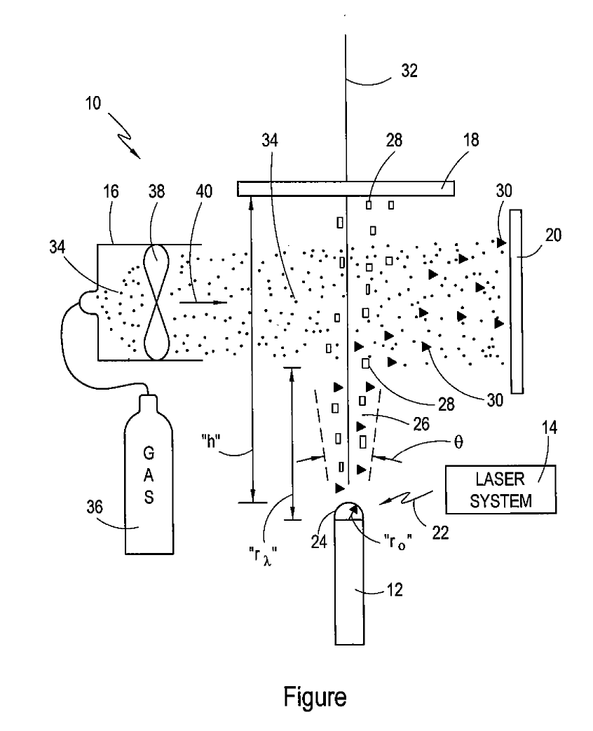

### FIELD OF THE INVENTION

The present invention pertains generally to methods and systems for separating the constituents of a composite material from each other. More particularly, the present invention pertains to separating vapor particles from each other according to the respective mass of the particles. The present invention is particularly, but not exclusively, useful as a winnowing process for separating particles in a vapor from each other according to the respective mass of the particles.

### BACKGROUND OF THE INVENTION

In a typical winnowing process, a flow of air (i.e. gas) is passed through a stream of particles. Specifically, the purpose of such a process is to separate different types of particles in the stream from each other. In particular, due to the fact that the energy loss of a particle in a winnowing process depends on its mass, the end result is the separation of relatively heavy particles from relatively lighter particles. Stated differently, as particles, atoms or molecules in a stream interact with a gas flow, the heavier particles will lose relatively little energy. On the other hand, the lighter particles will lose all of their directed energy, and will become entrained in the gas flow. As specifically recognized by the present invention, this process can be applied to vaporized materials that include particles of relatively high mass (M_{H}), and particles of relatively low mass (M_{L}).

It is known that when a material is vaporized, all particles of the vapor will depart from the evaporating surface of the material at a substantially same constant velocity. This happens, regardless of the mass of the vaporized particles. In the particular case wherein a laser beam is focused onto a material to vaporize the material, the resulting vapor will expand outwardly in a cone with an angle, θ. The particular methodology for using a laser beam to vaporize a material will depend, in large part, on the nature of the material.

For example, U.S. application Ser. No. 11/109,137 for an invention entitled “System and Method for Vaporizing a Metal”, and U.S. application Ser. No. 11/131,961 for an invention entitled “System and Method for Vaporizing a Solid Material” respectively disclose systems and methods for using laser systems to vaporize metals and ceramics. Both of these applications are assigned to the same assignee as the present invention, and both are incorporated herein, in their entirety, by reference. In any event, after the vapor has been created, particles in the vapor will behave in a predictable, albeit statistical, manner.

The efficacy of a winnowing process will, of course, depend on conditions in the vapor as well as the gas flow. Specifically, such a process is most efficacious when, as between each other, the vapor particles are essentially collision-free. On the other hand, the winnowing process must rely on the relative energy losses that occur with collisions between particles in the vapor and gas atoms that are introduced as a gas flow into the vapor. Collisions with the gas atoms will then cause the lighter vapor particles (M_{L}) in the vapor to lose their directed energy faster than the heavier vapor particles (M_{H}) that have relatively little loss of energy. Consequently, the lighter vapor particles, M_{L}, will become entrained in the gas flow and will be literally “swept away” by the gas flow. Meanwhile, the heavier vapor particles (M_{H}) that have relatively little loss of energy will be relatively unaffected. This separates M_{L}from M_{H}.

With the above in mind, consider the laser vaporization of a composite material that includes particles M_{H} and M_{L}. Further, consider that vaporization of the material occurs from an evaporating surface having a radius “r₀”, and that “n₀,” is the density of vapor particles at the evaporating surface. In this case, the density of particles (n) at a radius (r), where r>r₀, can be expressed as:
n=n₀r₀²/r²
As implied above, it is also to be taken that the velocity of all vapor particles at the radius “r” will still be substantially the same as they were at the evaporating surface “r₀” (e.g. v₁). Under these conditions, the mean collision free path (λ) among the vapor particles is expressed as:
λ=[σn]−¹

In the above expression, σ is the collision cross section of the vapor particles. Thus, when “r” is comparable to “λ” (i.e. r_{λ}), the vapor particles will no longer collide with each other. Stated differently, when the vapor particles have traveled to the distance “r_{λ}”, and beyond, they are, thereafter, essentially collision-free. Mathematically, this can be stated as occurring when:
λ≅r_{λ}=σn₀r₀²
wherein σ is a collision cross section of the vapor, no is the density of the vapor at the evaporation surface, and r₀ is a radius of the evaporation surface.

Now consider the circumstance wherein a gas having gas atoms of mass “m” is introduced into the vapor. Here, m<<M_{(L or H)}. Also, consider that, in this circumstance, the collision frequency between gas atoms and vapor particles is “ν”. Then, if “N” is the average number of collisions that are required for gas atoms to stop a vapor particle (e.g. for vapor particles M_{L}: N_{L}=M_{L}/m), it can be shown that the average range <R>of a vapor particle as it travels in the gas is:
<R>=[V₁/ν]N
The consequence here is that heavy mass particles (M_{H}) can be separated from the lighter mass particles (M_{L}) if the minimum range of the heavy mass particles (R_{H,min}) exceeds the maximum range of the lighter mass particles (R_{L,max}):
R_{H,min}>R_{L,max}
Statistically, it can be shown that when a vapor is directed along an axis in a “z” direction, and a gas flow is directed substantially perpendicular to the axis in an “x-y” plane, the gas flow will cause particles in the vapor to lose energy. Specifically, this occurs between z₀=λ=σn₀r₀² (i.e. the distance from the source where vapor particles become collisionless), and z=h (where h is effectively equal to R_{L,max}). In this case, the lighter vapor particles of mass M_{L} will not travel the distance “h” when:
V₁τ[1+N_{L}^{-1/2}]cosθ<h−z₀
wherein τ=N_{L}/νand θ is the cone angle of the vapor jet, and wherein v₁ is an entry velocity of M_{H}and M_{L}into the gas flow, τ is the time for the gas flow to stop M_{L}, N_{L} is the number of collisions between M_{L} and atoms in the gas flow required to stop M_{L}, and ν is the collision frequency.

In light of the above, it is an object of the present invention to provide a system and method for winnowing a vapor to separate vapor particles in the vapor from each other according to their respective masses. Another object of the present invention is to provide a system and method for separating high mass particles (M_{H}) and low mass particles (M_{L}) from each other which is relatively easy to use and comparatively cost effective.

### SUMMARY OF THE INVENTION

In accordance with the present invention, a system and method for employing a winnowing process to separate high mass particles (M_{H}) and low mass particles (M_{L}) from each other requires the vaporization of a solid target material containing both M_{H} and M_{L}. Preferably, a laser system is used for this purpose. As contemplated for the present invention, the solid target material is vaporized at an evaporation surface to create a vapor jet. In this case, the evaporation surface is considered to be curved and have a radius “r₀”. The vapor jet that is thereby created will have a conical shape, wherein θ is the angular spread, and it will be directed substantially along an axis.

The present invention also includes an injector for directing a gas flow (e.g. hydrogen or helium) along a path through the vapor jet. Importantly, the path of this gas flow will be substantially perpendicular to the axis of the vapor jet. Further, the gas flow needs to intersect the vapor jet on the axis, beyond a predetermined distance “z” from the evaporation surface. Specifically, the gas flow needs to intersect the vapor jet at distances from the evaporation surface that are beyond the mean collision free paths (λ) of the vapor particles. As discussed above, this circumstance occurs beyond a distance from the evaporating surface where θ is comparable to “r” (i.e. at a mean collision free distance “r_{θ}”). Thus, the gas flow intersects the vapor jet when z is greater than “r_{θ}”. In this instance, r_{θ}is determined by the expression r_{θ}=σn₀r₀²; wherein σ is a collision cross section of the vapor, and n₀ is the density of the vapor at the evaporation surface.

As the gas flow interacts with the vapor jet, and gas atoms collide with vapor particles, the particles M_{L} will be separated from the particles M_{H} when their respective ranges of travel (R) through the gas flow are such that R_{H,min}>R_{L,max}. With R_{H,min} taken to be at a distance “h” from the evaporating surface, it can be mathematically shown that the particles M_{L} will become entrained in the gas flow, and that separation of M_{L} from M_{H} will therefore occur when:
V₁τ[1+N_{L}^{-1/2}]cosθ<h−z₀ with τ=N_{L}/ν
In the above expression, v₁ is the entry velocity of M_{H} and M_{L} into the gas flow, τ is the time for the gas flow to stop the particles M_{L}, N_{L} is the number of collisions with atoms in the gas flow that are required to stop the particles M_{L}, and ν is the collision frequency.

During operation of the system of the present invention a first collector is positioned on the axis at the axial distance “h” from the evaporation surface to collect heavy particles M_{H} from the vapor jet. Additionally, a second collector is located on the path of the gas flow for collecting M_{L} from the gas flow. Preferably, the target material will be constituted such that M_{H} /M_{L}>1.5.

### BRIEF DESCRIPTION OF THE DRAWINGS

The novel features of this invention, as well as the invention itself, both as to its structure and its operation, will be best understood from the accompanying drawing, taken in conjunction with the accompanying description, in which similar reference characters refer to similar parts, and in which:

The Figure is a schematic representation, not to scale, of a system in accordance with the present invention, showing the path of vapor particles and gas atoms in a typical operation.

### DESCRIPTION OF THE PREFERRED EMBODIMENTS

Referring to the Figure, a device in accordance with the present invention for separating high mass particles (M_{H}) and low mass particles (M_{L}) from each other is shown, and is generally designated 10. In overview, the device 10 includes a target material 12 that is to be vaporized, and a laser system 14 for vaporizing the target material 12. Also included is a gas injector 16 for winnowing the vaporized target material 12, a heavy collector 18 for collecting high mass particles (M_{H}) from the vapor, and a light collector 20 for collecting low mass particles (M_{L}) from the vapor. For purposes of the present invention, the target material 12 may be either metallic or ceramic, and will include both high mass particles (M_{H}) and low mass particles (M_{L}).

As intended for the device 10 of the present invention, when activated, the laser system 14 generates a laser beam 22 that is directed toward, and is focused onto, the target material 12. The result of this is the creation of a molten portion of the target material 12 that has a generally spherical shaped evaporation surface 24 of radius “r₀”. With the evaporation of the target material 12, a vapor jet 26 is formed that includes the particles 28 having a relatively high mass (M_{H}), and the particles 30 having a relatively low mass (M_{L}). Preferably, the relationship between the particles 28 and the particles 30 will be such that M_{H} /M_{L}>1.5. In any event, the vapor jet 26 will be directed from the target material 12 in a generalized “z” direction along the axis 32, toward the heavy collector 18. As so directed, the vapor jet 26 will diverge from the axis 32 within a vapor jet angle “θ”.

The Figure also shows that a gas flow 34 is to be supplied by the injector 16 using a source of gas, such as a gas bottle 36. Preferably, the gas in gas flow 34 is either Helium or Hydrogen (note: Helium is to be used when Hydrogen will cause significant chemical reactions with the vapor 26). Further, as shown, the injector 16 will include an impeller, such as a fan 38, that will direct the gas flow 34 in a direction indicated by the arrow 40. Specifically, the direction that gas flow 34 is directed from the injector 16 should be substantially perpendicular to the axis 32 (i.e. perpendicular to the vapor jet 26).

In the operation of the device 10, the vapor jet 26 is created by focusing the laser beam 22 onto the target material 12. The resultant vapor jet 26, containing M_{L} and M_{H}, is then directed along the axis 32 toward the heavy collector 18. Simultaneously, the gas flow 34 is directed (arrow 40) toward the light collector 20. In combination, the orientation of the gas flow 34 relative to the vapor jet 26, the distant “r_{λ}” of the gas flow 34 from the target material 12, and the distance “h” of the heavy collector 18 from the target material 12 are important to the operation of the device 10.

As shown in the Figure, the heavy collector 18 is placed on the axis 32 at a distance “h” from the evaporation surface 24 of the target material 12. Importantly, the distance “h” is determined by the inability of the particles 30 (M_{L}) to continue travel along the axis 32, when limited by the influence of the gas flow 34 from injector 16. Simply stated, because collisions with gas atoms in the gas flow 34 will cause particles 30 (M_{L}) to loose energy faster than the particles 28 (M_{H}), the particles 30 (M_{L}) will be swept from the vapor jet 26 by the gas flow 34 before they have traveled the distance “h” along axis 32. The particles 30 (M_{L}) will then come into contact with the light collector 20. Due to their heavier mass, however, the particles 28 (M_{H}) will continue in a generally axial direction until they come into contact with the heavy collector 18.

It is also important in the operation of the device 10 that the gas flow 34 be, at least, at a distance “r_{θ}” from the evaporation surface 24 of the target material 12. Specifically, the gas flow 34 must be more than a mean collision free distance “r_{ν}” from the evaporation surface 24. In this case, rν =σn₀r₀², wherein σ is a collision cross section of the vapor 26, n₀ is the density of the vapor 26 at the evaporation surface 24, and r₀ is a radius of the evaporation surface 24. The consequence here is that the winnowing process needs to take place when particles 28 (M_{H}) and particles 30 (M_{L}) no longer collide with each other in the vapor 26 (i.e. at a distance greater than “r_{λ}”). On the other hand, once they are beyond the distance “r_{θ}” from the evaporation surface 24, the particles 28 (M_{H}) and particles 30 (M_{L}) will collide with gas atoms in the gas flow 34, and thereby be separated from each other.

As envisioned for the present invention, collection of the particles 28 (M_{H}) on the heavy collector 18, and collection of the particles 30 (M_{L}) on the light collector 20, happens under determinable conditions. Specifically, these conditions will exist when the heavy collector 18 is positioned on the axis 32 at the axial distance “h” from the evaporation surface 24, and h−r_{λ} satisfies the condition:
V₁τ[1+N_{L}^{8 -1/2}]cosθ<h−r_{ν}: withτ=N_{L}/ν
In the above expression, v₁ is an entry velocity of the particles 28 (M_{H}) and the particles 30 (M_{L}) as they enter the gas flow 34. “τ” is the time for the gas flow 34 to stop the particles 30 (M_{L}) from further travel in an axial direction, when N_{L} is the number of collisions between the particles 30 (M_{L}) and atoms in the gas flow 34 that are required to stop further axial travel of the particles 30 (M_{L}). Also, in this expression “ν” is the collision frequency between atoms in the gas flow 34 and the particles 30 (M_{L}) and “θ” is the angular spread of the vapor jet 26.

While the particular Chafftron as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A device for separating high mass particles (M_{H}) and low mass particles (M_{L}) from each other, said device comprising:
a target material containing M_{H} and M_{L};
a means for vaporizing the target material to create a vapor jet therefrom, wherein the vapor jet is created at an evaporation surface and is directed substantially along an axis;
an injector for directing a gas flow along a path through the vapor jet to entrain M_{L} in the gas flow, wherein the path of the gas flow is substantially perpendicular to the axis of the vapor jet;
a first collector positioned on the axis for collecting M_{H} from the vapor jet; and
a second collector located on the path for collecting M_{L} from the gas flow.

2. A device as recited in claim 1 wherein the gas flow intersects the vapor jet beyond a distance “z” along the axis from the evaporation surface, where z is greater than a mean collision free distance r_{λ}.

3. A device as recited in claim 2 wherein the first collector is positioned on the axis beyond an axial distance “h” from the evaporation surface, and h is a maximum axial distance for travel of the particles M_{L} from the evaporation surface.

4. A device as recited in claim 1 wherein the vaporizing means is a laser source and the target material is solid.

5. A device as recited in claim 1 wherein the vaporizing means is a laser source and the target material is a liquid.

6. A device as recited in claim 1 wherein M_{H}/M_{L}>1.5.

7. A device as recited in claim 1 wherein the gas in the gas flow is selected from a group consisting of helium and hydrogen.

8. A device as recited in claim 1 wherein the target material is metallic.

9. A device as recited in claim 1 wherein the gas flow has a substantially uniform density and a substantially constant velocity along the path.

10. A device which comprises:
a target material;
a means for vaporizing the target material to create a vapor jet directed along a predetermined axis, wherein the vapor jet includes relatively heavy particles of mass M_{H}, and relatively light particles of mass M_{L};
a gas flow means for directing a gas of substantially uniform density at a substantially constant velocity along a path to intersect the vapor jet within a distance “h” from the source of target material to entrain the particles of mass M_{L} in the gas flow, wherein the gas flow path is substantially perpendicular to the axis of the vapor jet;
a first collector positioned on the axis for collecting M_{H} from the vapor jet; and
a second collector located on the path for collecting M_{L} from the gas flow.

11. A device as recited in claim 10 wherein the gas flow intersects the vapor jet beyond a distance “z” along the axis from the evaporation surface, where z is greater than a mean collision free distance “r_{λ”.}

12. A device as recited in claim 11 wherein the first collector is positioned on the axis beyond an axial distance “h” from the evaporation surface, and h is a maximum axial distance for travel of the particles M_{L} from the evaporation surface.

13. A device as recited in claim 10 wherein M_{H}/M_{L}>1.5.

14. A device as recited in claim 10 wherein the gas in the gas flow is selected from a group consisting of hydrogen and helium.

15. A device as recited in claim 10 wherein the target material is metallic, said second collector is a cold collector, and said gas flow means is an injector.

16. A method for separating high mass particles (M_{H}) and low mass particles (M_{L}) from each other, said method comprising the steps of:
vaporizing a target material to create a vapor jet directed along a predetermined axis, wherein the vapor jet includes relatively heavy particles of mass M_{H}, and relatively light particles of mass M_{L};
directing a gas of substantially uniform density at a substantially constant velocity along a path to intersect the vapor jet within a distance “h” from the source of target material to entrain the particles of mass M_{L} in the gas flow, wherein the gas flow path is substantially perpendicular to the axis of the vapor jet;
positioning a first collector on the axis for collecting M_{H} from the vapor jet; and
locating a second collector on the path for collecting M_{L} from the gas flow.

17. A method as recited in claim 16 wherein the gas flow intersects the vapor jet beyond a distance “z” along the axis from the evaporation surface, where z is greater than a mean collision free distance “r_{λ}”.

18. A method as recited in claim 17 wherein the first collector is positioned on the axis at an axial distance “h” from the evaporation surface, and h is a maximum axial distance for travel of the particles M_{L} from the evaporation surface.

19. A method as recited in claim 17 wherein the gas in the gas flow is selected from a group consisting of hydrogen and helium.

20. A method as recited in claim 17 further comprising the steps of:
removing vapor particles from said first collector; and
repeating said vaporizing step using the vapor particles obtained during said removing step.
